(19) United States
(12) Patent Application Publication
(10) Pub. No.: US 2014/0250423 A1
(43) Pub. Date: Sep. 4, 2014

(54) Simulating Runtime Interactivity And Other Changes Within A Computer Content Creation Environment

(71) Applicant: Robert Tyler Voliter, San Jose, CA (US)

(72) Inventor: Robert Tyler Voliter, San Jose, CA (US)

(73) Assignee: Adobe Systems Incorporated, San Jose, CA (US)

(21) Appl. No.: 12/350,503

(22) Filed: Jan. 8, 2009

(51) Int. Cl. G06F 9/44

(52) U.S. Cl. 717/113

(57) ABSTRACT

Methods and systems are disclosed that facilitate the simulation of runtime interactivity and other changes for computer content within a content creation environment. Certain embodiments, allow interactivity and changes, such as animations and navigation, to be simulated at design time without leaving the design application, and in some cases within a same component display. Certain embodiments add a runtime simulation feature to a creation environment that conceptually allows the creator to interact with components displayed as if the creator were using “the user's hand.” Clicking a button, for example, allows the creator to observe how the button responds at runtime. Certain embodiments thus allow a creator to quickly move back and forth between design and simulated running to facilitate the creation and testing of many types of content involving interactivity and other changes.

### FIELD

Embodiments relate generally to the field of computing and specifically to computing applications used to create, control, and otherwise display user interfaces, applications, and other computer content.

### BACKGROUND

Various software applications facilitate the creation of user interfaces, rich media applications, and other computer content. For example, Adobe® Flex® technologies can be used to create Adobe® Flash® content using an XML-based markup language commonly called MXML™ to declaratively build and position visual components. This declarative code can specify the visual attributes of the content, including the locations and display attributes of the content's visual components. The declarative code may be automatically generated based on a creator having graphically laid out components (such as, for example, buttons) on a displayed creation canvas.

Generally, computer applications and other content can include visual, non-deterministic or interactive components, such as visual user interface components and logic or timeline triggered events. Developing such applications and content typically involves the use of one or more visual development and/or design applications, referred to herein generally as creation environments. To run and test an application, the creator typically makes a change in the creation environment, saves, compiles, and executes the created application or other content.

Various creation environments allow a creator to change an application while the application's code is running. Typically, an edit and continue function such as those offered in various Java environments, allows an application creator to compile and run a project and then make changes to the live application without re-running it. Changes are compiled and integrated into the application while it is running. Various applications also provides an edit-and-continue feature. In addition, certain development environments provide content in a browse mode that is interpreted and never compiled. Creation of such content can involve setting up rules about event responses, such as, for example, rules defining what happens when a button is clicked. Also, some slideshow and video editing applications allow the playing of a video or slideshow within a creation environment. Generally, certain applications allow switching between creation and running on the same display area.

However, generally, the various features of existing creation environments conceptually and graphically separate design/development from execution/browsing. Generally, switching between design/development and execution/browsing involves switching to a new window, tool set, and/or other screen attributes, often unnecessarily complicating the process of making a change and testing the change to an application or content being created.

### SUMMARY

Methods and systems are disclosed that facilitate the simulation of runtime interactivity and other changes for computer content within the content creation environment. Certain embodiments allow interactivity and changes, such as animations and user navigation, to be simulated at design time without leaving the design application, and in some cases within a same component display. Certain embodiments add a runtime simulation feature to a creation environment that conceptually allows the creator to interact with components displayed as if the creator were using “the user's hand.” In other words, a user hand feature results in keyboard and mouse input from the creator being interpreted as if it were user input received while interacting with the running application. The term “user's hand” is not intended to limit the type of inputs to those received from a person's physical hand. Such inputs can refer to any input received during runtime including, but not limited to touch screen inputs, mouse inputs, stylus inputs, verbal commands, and tablet commands, among others. Clicking a button, for example, allows the creator to observe how the button would respond at runtime. Certain embodiments thus allow a creator to quickly move back and forth between design and simulated running to facilitate the creation and testing of many types of content involving interactivity and other changes.

One embodiment provides a method of simulating changes within a content creation environment. The method involves providing, for display and editing, representations of one or more components of content being created or edited. The method further involves receiving a selection of a runtime change simulation feature initiating a simulation of runtime changes of the representations of the one or more components. The representations of the components displayed respond to events as the components would respond during runtime. The method further involves monitoring for events and, if one or more events are identified, changing representations of the one or more components as the components would be changed at runtime in response to the one or more events. The method also involves ending the simulation of runtime changes and again providing representations of components for display and editing.

In other embodiments, a computer-readable medium (such as, for example, random access memory or a computer disk) comprises code for carrying out the methods and systems described herein.

These illustrative embodiments are mentioned not to limit or define the invention, but to provide examples to aid understanding thereof. Illustrative embodiments are discussed in the Detailed Description, and further description of the disclosure is provided there. Advantages offered by various embodiments of this disclosure may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 illustrates an exemplary system environment for creating applications and other content, according to certain embodiments;

FIG. 2 illustrates an exemplary user hand feature of a content creation environment, according to certain embodiments;

FIG. 3 is a flow chart illustrating an exemplary method of simulating changes within a content creation environment, according to certain embodiments; and

FIG. 4 is a flow chart illustrating an exemplary method of determining any changes required for a non-static state according to certain embodiments.

### DETAILED DESCRIPTION OF EXEMPLARY EMBODIMENTS

Certain embodiments facilitate the creation of applications, interactive experiences, and other computer content by providing a creation environment feature that allows a creator to simulate runtime inputs and other runtime changes in the creation environment. For example, design and development features may be used to create an application by positioning graphics and text displayed on a canvas in a creation environment. The creation environment may further allow a creator to define interactivity and other input-based or state-based changes that will occur during runtime in the application. Certain embodiments described herein provide a tool or other feature that allows a creator to run interactivity and input-based or state-based changes within the creation environment.

As a specific example, a creator may position a button and a circle on a canvas and define that when the button is clicked the circle will move in a certain way. The creator may then click on a runtime-simulation tool to test this interactivity. After selecting the runtime-simulation tool, when the user clicks on the button on the canvas in the creation environment, the creation environment changes as if it were the runtime environment. In this case, the circle moves on the canvas as it would in the runtime environment. The creator is thus able to test the defined interactivity without leaving the creation environment and without separately executing the application. After using the runtime-simulation tool, the creator may select a design or development tool and continue editing the application being developed.

A runtime simulation tool can be referred to as a “user hand” tool in that it allows a creator to interact with an application being created as if the creator were interacting with a running application. As another example, after writing the code defining what happens when a user enters various characters into a text field, such as, for example, code that checks a phone number for parentheses, area code, international code, etc., the creator can use a user hand tool to test the text field. If the creator selects the user hand tool and then types into the text field, the creation environment responds in the same way as the runtime environment, in this example, giving the user a response as to whether the phone number is valid or not. A user hand tool can generally be used to signal that any input that is received during use of the user hand tool should be treated as runtime input. Thus, in addition to mouse selections and keyboard commands, use of a user hand tool can also simulate the runtime response to other input that may be received at runtime, including but not limited to input from tablet, track pad, joystick, game controller, speech entry, touch screen, and gesture/motion sensing devices. In the above text field example, as the creator creates logic about what is valid and what is not valid, the creator can use a user hand tool to test editing of the text field. In this way, problems can be more quickly identified and corrected or otherwise resolved.

These illustrative examples are given to introduce the reader to the general subject matter discussed herein. The disclosure is not limited to these examples. The following sections describe various additional embodiments and examples of methods and systems for facilitating the creation of applications and other computer content by providing a creation environment feature that allows a creator to simulate runtime inputs in that environment.

### Illustrative Authoring and Runtime Environments

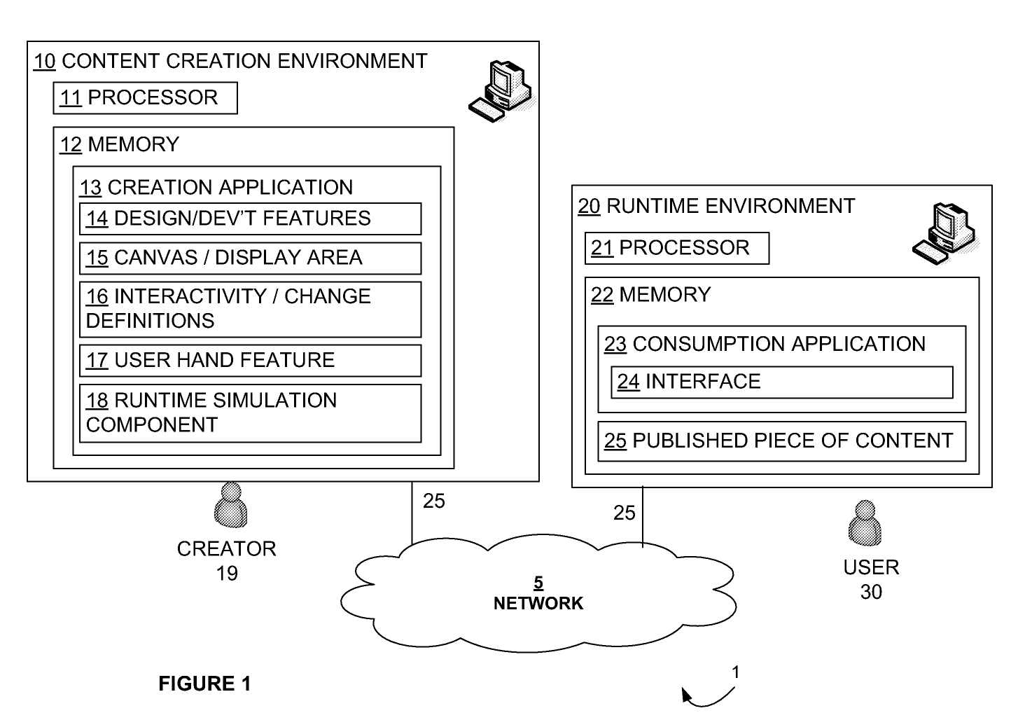

Referring now to the drawings in which like numerals indicate like elements throughout the several figures, FIG. 1 is a system diagram illustrating a content creation environment 10 and an exemplary runtime environment 20 according to certain embodiments. Other embodiments may be utilized. The system 1 shown in FIG. 1 comprises a content creation environment 10, which may, for example, include a computing device that comprises a processor 11 and a memory 12. A creator 19 uses the content creating environment 10 to author an application or other content. The memory 12 may comprise a creation application 13 with design/development features 14, one or more canvas or display areas 15, interactivity/change definitions 16, a user hand feature 17, and/or a runtime simulation component 18 that the creator uses for such authoring. A creation environment in alternative embodiments may include features running on a server such that only the user interface of the creation environment is provided on a creator's local computing device.

In FIG. 1, the design/development features 14 allow a creator to create various aspects of an application or other content. For example, one or more component placement features may allow a creator 19 to position and define buttons, text, and other graphics on a canvas/display area 15 maintained in the memory associated with the creation application 13 and displayed on a user interface used by the creation application 13. Others of the features 14 may allow a creator 19 to enter and edit declarative statements and other computer code defining the appearance and/or functionality of the content and its components. As another example, design/development features may provide input areas for a creator to enter parameters or other information defining the appearance and/or functionality of content being developed.

In this exemplary creation application 13, a creator may place, position, and otherwise define components by positioning the components on the canvas/display area 15. Information about such objects may be stored in memory 12 or could be stored locally on disk or remotely on a server. The creation application 13 may allow the creator 19 to create and use components, for example, by allowing the creator 19 to position components and create and revise relationships between components. The graphically positioned components may be used by the creation application 13 to automatically generate computer code or other content specifying the appearance attributes of the graphical components.

Generally, during creation the canvas/display area 15 provides visual feedback about one or more static states of the content. When the creator further defines interactivity or other changes by providing or specifying interactivity/change definitions 16, the creator can observe the defined interactivity or changes using a user hand feature 17 provided by the creation application 13. For example, the user may select the user hand feature 17 and then mouse click on a button that is displayed on the canvas/display area 15. In response, the canvas/display area 15 may mimic the runtime response of the button click. The response(s) is defined by the interactivity/change definitions 16 that were created by the creator 19 or otherwise specified within the creation application 13. As a few examples, the canvas/display area 15 may show a component moving on the screen, text changing, displaying data retrieved from a data source, a switch or transition to an different state, etc.

In some cases, simply clicking on the user hand feature may initiate mimicking of the runtime of the application or content. For example, an application or content may specify a change to a given component regardless of interactivity. One example of continuous running is a button that has a pulsing glow animation defined on it that constantly runs. Upon selection of a user hand feature 17, the canvas/display area 15 may (or in some cases may not) begin any such change. In this example, the button may begin the pulsing glow animation. Accordingly, in addition to mimicking the runtime behavior of interactivity, a user hand can be used to initiate that mimicking of other changes specified for an application or other content. As another example, a widget may be connected to a data service that updates when there is new data, for example, upon occurrence of a data event rather then user input. Selection of a user hand feature may thus initiate or facilitate simulation change occurring in response to events triggered by user or other events.

Selection of a user hand feature 17 may also allow the creator to mimic the runtime of an application or other content from a point other than the beginning of the content. For example, if an application has several states beginning with a login state, and also including product search, product review, and checkout states, a creator can, after specifying the appearance/functionality of the checkout state using the canvas/display area 14 and interactivity/change definitions 16, use the user hand feature 17 to test the runtime interactivity or other changes for the checkout components without having to navigate through the other states. For example, if the canvas/display area displays the buttons and other components of the checkout state and the creator selects user hand feature 17 and selects a given button, the canvas/display area may display how the application changes from that point, without requiring the creator to navigate through the login and other states as the creator might have to do in an actual runtime test.

Runtime simulation component 18 can be used to facilitate the user hand feature 17, for example, by determining how the canvas/display should change to mimic the runtime environment. For example, a runtime simulation component 18 may interpret, parse, or compile some or all of the current code associated with an application. This information can be compared to the particular components and/or the state of the application or content that are currently being edited. For example, a runtime simulation component 18 may compile the code of an application in the background and step through the code to identify the code corresponding to the interactivity and other changes associated with the state, such as, for example, a checkout state, that is currently being edited. The runtime simulation component 18 may then modify the canvas/display area according to changes specified as if the canvas/display area were the display area of the executing application or content. In certain embodiments, a runtime simulation component could actually run a compiled application and facilitate the injection of changes into the running application.

A creator may also actually run the application or content in the content creation environment 10 and may ultimately publish the finished content for distribution through network 5. For example, a piece of content 25 may be sent to another location, for example, through a network 5 to a runtime environment 20. The runtime environment may also include a processor 21 and a memory 22. The memory 22 will generally include a consumption application 23 that provides an interface 24 for viewing or otherwise consuming pieces of content. The piece of content 25 may be stored in memory 22 and viewed or otherwise consumed by a user 30 using the interface 24 of the consumption application 23.

### Illustration of Exemplary User Hand Feature

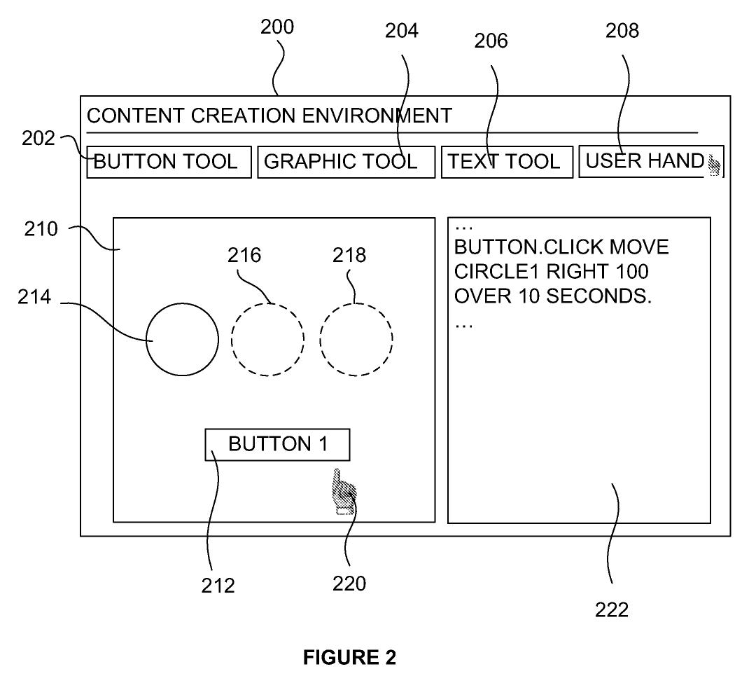

FIG. 2 illustrates an exemplary user hand feature of a content creation environment 200, according to certain embodiments. The content creation environment 200 includes a canvas area 210 for positioning graphics, text, and other components that will be displayed as part of the display of content being developed. The event definition area 214 is used to define interactivity and other changes associated with the content. The content creation environment 200 includes various design tools 202, 204, 206 including a button tool 202, a graphic tool 204, and a text tool 206. The content creation environment 200 also includes a user hand feature that can be selected by the user hand tool 208. This creation environment is intentionally simplified to facilitate understanding of certain aspects of certain embodiments. Other creation environments including those having differing and/or additional features may also be used.

In the example shown in FIG. 2, a creator has used the button tool 202 to add and position BUTTON1 212 on the canvas area 210 and used the graphic tool 204 to add and position a circle 214 (which has ID CIRCLE1) at a position towards the left side of the canvas area 210. The creator has also used the event definition area 222 to define a change for the content. Specifically, the description “BUTTON.CLICK MOVE CIRCLE 1 RIGHT 100 OVER 10 SECONDS” defines a movement that will occur upon the event of a mouse click on the button during execution of the content being developed. It should be understood that this pseudo-code and the event definition feature 222 used in this example are merely illustrative and a variety of other graphical, text, and code-based techniques and interfaces can be used to define interactivity and change for content.

Having defined this interactivity, the creator may wish to test or observe the interactivity. The creator simply selects the user hand tool 208 and positions the user hand icon 220 to simulate a runtime mouse movement. With the user hand tool 208 selected, when the creator positions user hand icon 220 on the BUTTON1 212 and clicks the mouse button, the creation environment responds by performing the defined movement on the canvas area 210. In this case, the circle 216 moves from its initial position 216 through a series of intermediate positions, such as position 216, to its ending position 218 over the defined 10 seconds. The creator was thus able to test the interactivity of the content without having to leave the creation environment.

### Illustration of Exemplary User Hand Feature in Declarative Code Context

A user hand feature may be beneficial in the context of a creation application that uses declarative code to define the appearance of content, including how the appearance changes. As used herein “declarative code” is any code that defines content using one or more declarative statements. Declarative code can generally be parsed without being compiled and can have various formats. In one exemplary format, declarative code is used to define effects that cause a change in something over time. For example, a move effect can specify that a displayed component starts at one position and ends at another position over a specified time period. A rotate effect can rotate a displayed object at given rate over a given time.

In certain embodiments, a parsing and simulation engine can interpret declarative code and produce or simulate interactivity and other changes occurring in a piece of content or a specific portion of a piece of content. As a specific example, if a creator is editing a particular state of a piece of content, such as a check out state, and selects a user hand tool, in order to show changes or respond to interactivity initiated by the creator, the creation application may parse the appropriate portions of the declarative code. For example, when the creator mouse clicks on a button, the creation application can parse the declarative code and determine the effects caused by the button click event.

Declarative code can be used to define a variety of component attributes, interactivity, and changes. For example, a creator may use declarative code to define constraints such that one component collapses when another component is not collapsed. Another example is a timeline created by declarative code that specifies actions that components take over a given amount of time. Actions and effects in such a timeline can be described declaratively so that implementing user hand functions does not need to compile script code.

In certain embodiments, a creation environment allows the creation of visual components that are displayed on a creation canvas area. The creation canvas area mimics a state or appearance of the application, allowing the creator to observe how the application will appear. The creation application may store information about the displayed canvas area, such as the location and other appearance attributes of the components positioned on the canvas area. Such stored information may have a declarative format and can also include any interactivity or other change attributes defined for the content being developed. When the creator selects the user hand feature, the declarative code can be parsed for code relevant to showing the appropriate interactivity and other changes called for by the user hand feature.

In other words, the development environment can use a storage mechanism, such as a declaratively formatted file, to store information about the appearance and changes associated with an application being developed. Storing this information can facilitate both the traditional static display of an appearance of the application and the display of interactivity and other changes, in which the static appearance and changes are displayed on the same canvas area. The reuse of the same canvas area for these different functions can simplify and enhance the creation experience for the creator.

### Illustration of Exemplary Runtime Simulation Features

As described above, in some embodiments, runtime simulation can be achieved by simply parsing declarative code to locate and use appropriate change descriptions. In certain embodiments, a creation environment provides non-declarative mechanisms for describing interactivity and other changes. For example, a state machine or video editing sequence log may be used. In other cases, the interactivity and other changes are defined in more traditional scripting language. In these environments, a user hand tool can cause a simulated runtime of the content. Code can be compiled into some other form like machine language and interpreted on an ongoing basis. Alternatively, the creation environment may be able to pull out a piece of a description that is independent of other portions of code and either compile it or otherwise interpret it to accomplish the runtime simulation.

A user hand tool may cause a simulated runtime to navigate to a particular view or state of the content, which may be a view or state other than the starting state of the content. In some cases, this may require compiling code and navigating to an appropriate point and/or identifying the state or location within the running application so that when the creator exits the user hand feature, the creation application seamlessly presents the same state for further editing. For example, a simple application may provide different screen layouts and functionality for example: a password login, a list of books being sold, and detailed information for each book. To work on the detail information screen layout, the application user may have to login and click on an item in the list. In the context of a creation tool offering a user hand feature, a creator may edit the detailed information screen layout, launch a user hand feature to test or observe the changes and interactivity of that screen, and then return editing the detailed information screen layout.

There are various ways for a user hand tool to provide the appropriate portion of the runtime, in this case the detailed information screen. For example, it could simply execute a runtime in the background and navigate through all the possible paths through the runtime until the desired detailed information screen definition information is found. Alternatively, an algorithm may be used to determine a more efficient way to navigate to the detailed information screen. When a user clicks on the user hand icon, the design tool may identify an appropriate steady state within the application. The first code that executes is in reaction to something that the creator does with the user hand tool. For example, the creator may click on a button and the creation environment determines how the runtime responds to a user clicking on that button and emulates the appearance change in the creation environment, displaying whatever click event triggered actions are tied to the clicked button.

A visually-based creation environment generally must use some representation of the content that is being created, such as a file, text, a collection of files, and some program that reads that representation and presents a visual description of display of content. In the preceding example, this display involved a canvas area upon which components are displayed. The creation environment may allow editing of the displayed content. For example, a button may be repositioned. However, unlike in the past where the display area was used to display a static description of content, certain embodiments utilize the same display area to allow a creator to observe and, in some case, define interactivity. Creating an application or content can involve creating something that cannot be statically viewed, including things that involve user input or that are otherwise nondeterministic in the sense of having dependencies on other pieces, such as changes defined by if/then type logic. While in the past, a creator could not observe interactivity and other changes without running the content outside the creation environment, certain embodiments allow the creator to observe and even edit interactivity and other change behavior by mimicking the runtime changes within the creation environment.

Certain embodiments allow a user hand feature to be used to mimic a steady state of an application. In such cases, upon selection of a user hand tool, the creation application does not change until input is received from the creator. For example, the creator may mouse click on a component or use the computer keyboard to provide input. Thus, in these cases, after selection of a user hand tool, the creation environment is simply waiting for input from the creator identifying an event or something else that triggers an event. When an event is triggered, the creation environment simulates the defined event response, for example, by parsing the appropriate declarative code, compiling something, building needed data structures, etc.

Certain embodiments also allow a user hand feature to be used to mimic a non-steady state application and application portions that involve event loops that repeatedly respond to other user events or machine events to drive a next state. In these cases, the event loops are used to cause some or all of the changes to the application or other content. Many rich Internet applications, for example, have changes occurring even in the absence of user initiated or other triggering events. Examples of such changes occur in video streaming and animations. Thus, in the case of an event loop, some components may change based on the simple passage of time. As examples, a movie may play its next frame, an animation may move, data download may continue, etc. A user hand feature could be used to mimic these changes. For example, upon initiation of a user hand feature, the creation environment may determine an appropriate starting point and begin simulating such changes, even prior to a user initiated event.

While determining an appropriate starting point can be accomplished in a variety of ways, certain embodiments utilize embedded references to determine an appropriate starting point. For example, an Adobe® Flash® application that is being developed may include anchors or other references to facilitate deep linking or direct linking upon deployment of the application, for example, allowing uniform resource locator (URL) addresses to be associated with specific portions of the application. As with an anchor added to facilitate deep linking or direct linking, an anchor can be associated with a particular state, timeline frame, or other portion of an application to facilitate a user hand feature's identification of an appropriate point to start a simulation. For example, an anchor associated with the part of the application currently being developed may be identified and used to provide the appropriate portion of the runtime of the application being developed. Thus, generally, in certain embodiments, the simulation of a portion of content can be provided without compiling the entire content. Generally, declarative code facilitates the simulation of only portions of content, although, it is possible even in the absence of declarative code.

A user hand feature may also be used to simulate state transitions and other component changes. For example, it may be used to simulate the appearance of a collapsible panel as it transitions between its expanded and its collapsed appearances. A user hand feature may also be used to simulate motion and the interaction or appearance of moving components. For example, layout logic of an application may define how various components reposition themselves as their surrounding components are repositioned, moved, appear, or disappear.

Certain embodiments provide advantages in the context of providing a creation application through a web page or as a software-as-a-service service. By not forcing a creator to jump to another screen, the creation environment is improved and the creator's experience simplified.

A user hand feature also has particular advantages in contexts where it is useful to repeatedly switch between creation and testing. For example, creating smart forms may involve creating logic about error conditions. A user hand feature can be used to switch back and forth between creation/runtime without loosing entered testing data. This can be implemented, for example, by having the user hand feature retain inputted information even when it is not selected, that is, when the creation environment has returned to creation mode.

### Illustrative Method of Simulating Runtime Changes Within A Content Creation Environment

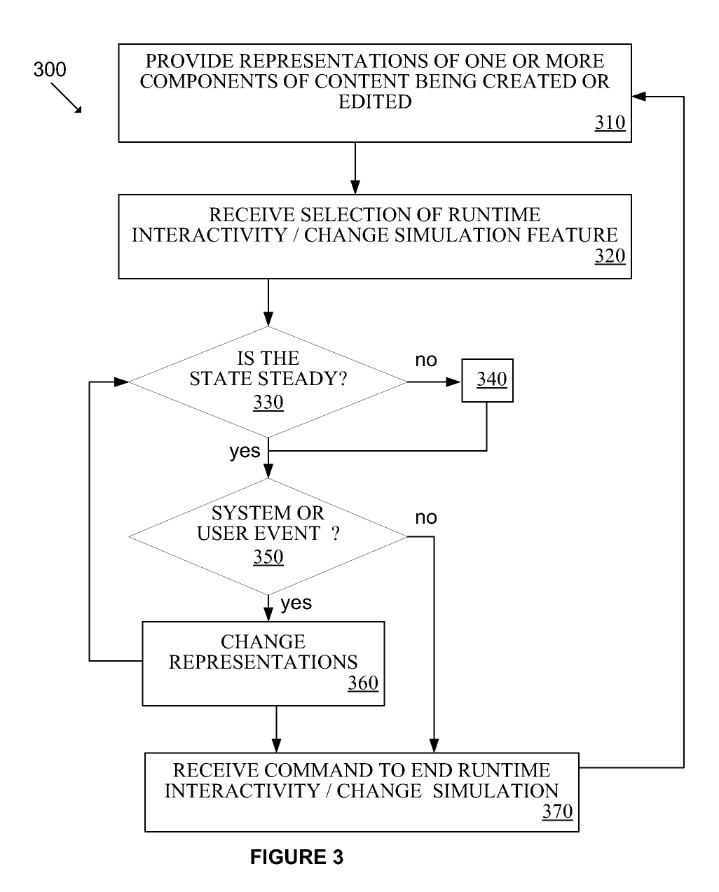

FIG. 3 is a flow chart illustrating an exemplary method of simulating changes within a content creation environment, according to certain embodiments. For purposes of illustration only, the elements of this method 300 may be carried out in a development environment such as the content creation environment 10 of the system 1 depicted in FIG. 1. A variety of other implementations are also possible.

The method 300 comprises providing for editing representations of one or more components of content being created or edited, as shown in block 310. For example, visual components may be displayed on a canvas area. Component representations may alternatively or in addition be displayed numerically. For example, a component representation may be displayed as a list of properties. A component may be edited in a variety of different ways depending upon the particular embodiment. For example, if an embodiment involves an editing environment with an editing canvas, the editing may occur in response to a creator repositioning, resizing, or otherwise changing the appearance and/or other attributes of components displayed on the editing canvas area.

The method 300 further comprises receiving a selection of a runtime interactivity/change simulation feature, as shown in block 320. Selection of this feature allows initiation of simulation of interaction or changes of the representations of the one or more components that can occur during runtime of the content being created or edited. The user hand feature described with respect to certain embodiments is an example of a runtime interactivity/change simulation feature.

The exemplary method 300 then determines, as shown in block 330, whether a state of the content from which the simulation will begin is steady or not. The selected state may be, in some embodiments, associated with the representations of one or more components provided for display. In some embodiments, the runtime simulation may begin from the initial state of the application regardless of the components being displayed. The determination of whether the state is steady or not may involve, for example, determining whether any on-going changes are associated with the state such as changes occurring even in the absence of creator initiated or other triggering events. For example, determining whether any of the components of the state are animated based on simply being in the given state. If the state is steady, the method proceeds to block 350.

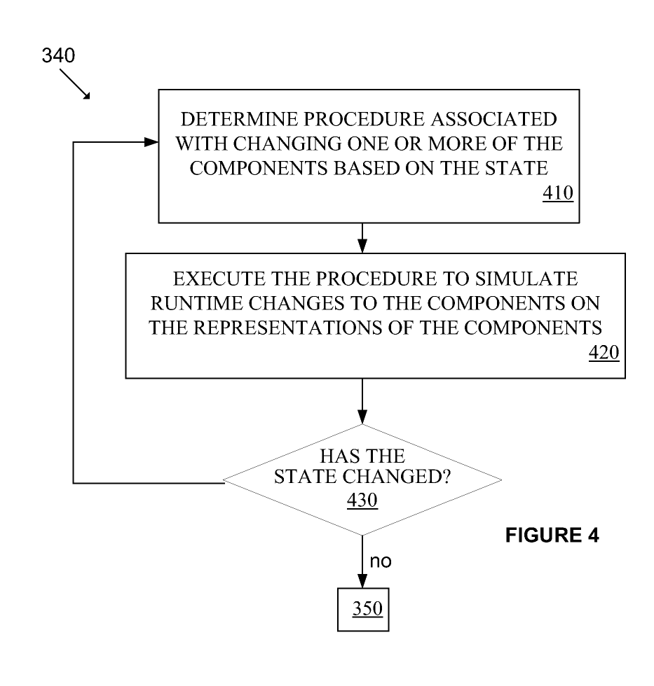

If the state is not steady, the method proceeds to block 340 to determine and make any changes required for the non-steady state. FIG. 4 illustrates an exemplary method of determining and making any changes required for a non-steady state 340 according to certain embodiments. The method of determining and making any changes required for the non-steady state 340 comprises determining one or more procedures or other logic associated with changing one or more of the components in the state in which the runtime simulation will begin, as illustrated in block 410. For example, this may involve identifying a block of procedural or other computer code associated with the state. As another example, it may involve identifying that a given component is a video that plays while the content is in the state. As another example, it may involve identifying other types of logical information that defines or specifies a change to a component over time in the state.

The method of determining and making any changes required for the non-steady state 340 further comprises executing or using the procedure to simulate runtime changes to the components on the representations of the components, as shown in block 420. Executing in this case refers to performing the one or more procedural instructions of the procedure, however, other embodiments can involve other types of procedure use. For example, if the content includes a video component, executing or using the procedure may involve using a procedure to play the video within the video component representation on an editing canvas. Generally, any suitable means of simulating a non-steady state of content may be used. In some cases, all or a portion of code associated with the content may be compiled to enable the simulation.

The method of determining and making any changes required for the non-steady state 340 further comprises monitoring whether the state has changed, as shown in block 430. For example, executing the procedure at block 420 may have caused the state of the content to change, in this case prompting the method 340 to return to block 410 to determine any further procedures required for the new state. If the state has not changed, the method 340 can continue to block 350 of FIG. 3.

Returning to FIG. 3, the method 300 also involves monitoring for any system or user events, as shown in block 350. For example, this may involve monitoring for any user interaction with a representation of a component displayed on an editing canvas area. As a particular example, this may involve monitoring for a click of a button component representation displayed on such a canvas area. Other types of input including, but not limited to, other mouse clicks, keyboard strokes, and other commands may also trigger user events. System events may be triggered as a result of a change triggered by a first event, a change to the state of the content, and other changes based on particular events and/or time-based indications.

Entering the runtime simulation feature in certain embodiments has the effect of making all representations of components displayed responsive as if the display were the runtime display. Buttons, lists, text boxes, shapes, graphics, linked objects, data, and any other type of components can change and/or respond as it would in the runtime environment. In certain embodiments, using a runtime simulation feature provides a different selector icon that allows a creator to recognize when the creation environment is operating in a runtime simulation mode. For example, the on screen selection indicator may appear like the hand 220 of FIG. 2 to distinguish it visually from the selection and other mouse icons used when the creation environment is not operating in runtime simulation mode.

If one or more system or user events are identified, the method 300 further involves making appropriate changes to the representations of the components, as shown in block 360. For example, this may involve identifying an appropriate block of code corresponding to a particular event that occurred, and performing changes based on the block of code. As a specific example, if a block of code identifies that, upon a click of a given button, information from an Internet address will be retrieved and displayed in a text component, the method may perform these tasks and display the retrieved text in a representation of the text component on a displayed editing canvas area. If the runtime simulation continues, the method 300 returns to decision block 330 to again determine whether the current state is a steady state.

As shown in block 360, the runtime simulation concludes when the method receives a command to end the runtime interactivity/change simulation. Such a command may be received implicitly through the receipt of another command. For example, the method may recognize that the runtime simulation is over based on receiving a selection of an editing tool. After receiving the conclude simulation command, the method 300 can return to block 310 to display the representation of components for editing. In certain embodiments, this may involve displaying representations according to the state of appearance of the content upon exiting the runtime simulation. In other words, as an example, if a creator enters the runtime simulation on a log-in screen and navigates though the runtime to a checkout state and selects to end the runtime, an editing canvas can continue displaying the checkout state component representations. In other embodiments, the edit state can return to the state it was in prior to initiation of the runtime simulation feature. In some embodiments, the representations provided for editing upon conclusion of a runtime simulation will depend upon creator preferences. This can allow a creator to select an appropriate interface for particular editing and/or testing tasks.

### Illustrative Method of Simulating Runtime Changes Within An Integrated Development Environment

One exemplary method of certain embodiments provides an integrated development environment (IDE). In that environment, a canvas is presented with components of an application under development. The application will also be represented, at least in part, by source code accessible for viewing and/or editing within or through the IDE. Thus, the source code, in many cases, reflects or provides a textual definition for the components displayed on the canvas area.

This exemplary method further comprises presenting a component manipulation tool in the IDE. The component manipulation tool allows the developer to adjust spatial positions of the components. Such adjustments of spatial positions of the components cause alterations in the source code. The method further comprises activating a simulation tool in the IDE. While the simulation tool is active, inputs acting upon components in the canvas do not alter the source code of the application.

The exemplary method comprises activating the simulation tool and receiving an input acting upon a component in the canvas. The input initiates a simulation of an interaction with the component during runtime of the application. In other words, the component (and the rest of the application) responds to the input in a way that simulates the component (and applications) response to the input during runtime of the application.

### General

Numerous specific details are set forth herein to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter. Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing platform, such as one or more computers or a similar electronic computing device or devices, that manipulate or transform data represented as physical electronic or magnetic quantities within memories, registers, or other information storage devices, transmission devices, or display devices of the computing platform.

Certain embodiments provide techniques for facilitating the simulation of runtime interactivity and other changes for computer content within a content creation environment. These embodiments are merely illustrative. In short, the techniques and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

In addition, with respect to the computer implementations depicted in the Figures and described herein, certain details, known to those of skill in the art have been omitted. For example, software tools and applications that execute on each of the devices and functions performed thereon are shown in FIG. 1 as functional or storage components on the respective devices. As is known to one of skill in the art, such applications may be resident in any suitable computer-readable medium and execute on any suitable processor. For example, the devices each may comprise a computer-readable medium such as a random access memory (RAM), coupled to a processor that executes computer-executable program instructions stored in memory. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, JavaScript, ActionScript, MXML, and CSS.

While the network shown in FIG. 1 may comprise the Internet, in other embodiments, other networks, such as an intranet, or no network may be used. Moreover, methods may operate within a single device. Devices can be connected to a network 100 as shown. Alternative configurations are of course possible. The devices may also comprise a number of external or internal devices such as a mouse, a CD-ROM, DVD, a keyboard, a display, or other input or output devices. Examples of devices are personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or media content consuming programs. The server devices may be single computer systems or may be implemented as a network of computers or processors. Examples of a server device are servers, mainframe computers, networked computers, a processor-based device, and similar types of systems and devices.

1. A computer implemented method comprising:
providing, for display and editing, representations of one or more components of content being created or edited;
receiving a selection of a feature initiating a simulation of runtime changes of the representations of the one or more components, wherein the representations of the one or more components respond to events in a same way that the components respond during runtime;
determining whether any on-going changes are associated with a starting state of the simulation of runtime changes and, if any on-going changes are associated with the starting state, changing the representations of the one or more components;
identifying one or more events and changing the representations of the one or more components in the same way that the components change at runtime in response to the one or more events; and
after ending the simulation of runtime changes, providing representations of components for display and editing.

2. (canceled)

3. The method of claim 1, wherein changing the representations of the one or more components comprises determining logic associated with changing a component in the starting state and using the logic to simulate runtime changes to the components.

4. The method of claim 3, wherein determining logic comprises identifying a portion of code associated with the starting state.

5. The method of claim 3 further comprising identifying that a component is a video and wherein using the logic to simulate runtime changes comprises displaying the contents of the video.

6. The method of claim 3, wherein using the logic to simulate runtime changes comprises compiling code.

7. The method of claim 3 further comprising monitoring whether state of the content changes.

8. The method of claim 1, wherein the starting state is a state associated with the representations of one or more components currently provided for display and editing.

9. The method of claim 1, wherein the starting state is a state associated with an initial runtime appearance of the content.

10. (canceled)

11. The method of claim 1 further comprising providing the representations of the one or more components for display on a canvas area that allows static component appearance to be edited and wherein the simulation of runtime changes displays changes to the representations on the canvas area.

12. The method of claim 11, wherein monitoring events comprises monitoring for user interaction with a representation of a component displayed on the canvas area.

13. The method of claim 1, wherein the simulation of runtime changes provides a different selector icon that differs from any selector icon or icons used when the creation environment is not simulating runtime changes.

14. The method of claim 1 further comprising identifying a portion of code corresponding to an event and performing changes based on the portion of code.

15. The method of claim 14 further comprises compiling the portion of code.

16. The method of claim 1, wherein ending the simulation of runtime changes is triggered by receiving a command to end the simulation.

17. The method of claim 1, wherein ending the simulation of runtime changes and providing representations of components for display and editing comprises providing the representations for display according to the starting state.

18. The method of claim 1, wherein ending the simulation of runtime changes and providing representations of components for display and editing comprises providing the representations for display according to a state of the content associated with the representations at the ending of the simulation.

19. A system comprising:
a processor executing stored instructions to provide:
a creation feature for creating content comprising one or more components;
a canvas area for displaying and editing a static view of representations of the one or more components;
a change component for defining a change for the one or more components, the change occurring during runtime of the content and in response to an event; and
a component for initiating a simulation of runtime changes of the representations of the one or more components, wherein in the simulation of runtime changes respond to events in a same way that the components respond during runtime, wherein the simulation of runtime changes provides a different selector icon that differs from any selector icon or icons used when not simulating runtime changes; and
a runtime simulation component that monitors for events and, if one or more events are identified, changes the representations of the one or more components on the canvas area in a same way that the components change at runtime in response to the one or more events.

20. The system of claim 19, wherein the component for initiating a simulation of runtime changes comprises a user hand component.

21. A non-transitory computer-readable medium on which is encoded program code, the program code comprising:
program code for providing, for display and editing, representations of one or more components of content being created or edited;
program code for receiving a selection of a feature initiating a simulation of runtime changes of the representations of the one or more components, wherein the representations of the one or more components respond to events in a same way that the components respond during runtime, wherein the simulation of runtime changes provides a different selector icon that differs from any selector icon or icons used when not simulating runtime changes;
program code for identifying one or more events and changing representations of the one or more components in the same way that the components change at runtime in response to the one or more events; and
program code for ending the simulation of runtime changes and providing representations of components for display and editing.

22. (canceled)

23. A computer implemented method comprising:
in an integrated development environment (IDE), presenting a canvas including components of an application under development, the application being represented in part by source code;
presenting a component manipulation tool to adjust spatial positions of the components, wherein adjustments of spatial positions of the components cause alterations in the source code;
activating a simulation tool in the IDE, wherein while the simulation tool is active, inputs acting upon components in the canvas do not alter the source code of the application, wherein the simulation of runtime changes provides a hand-shaped selector icon that differs in appearance from any selector icon or icons used when the creation environment is not in the simulation;
while the simulation tool is active, receiving an input acting upon a component in the canvas, wherein the input initiates a simulation of an interaction with the component during runtime of the application.
